(19) United States
(12) Patent Application Publication
(10) Pub. No.: US 2022/0203543 A1
(43) Pub. Date: Jun. 30, 2022

(54) ARRANGEMENT AND METHOD FOR ADJUSTING A ROBOT ARM

(71) Applicant: WALTER Maschinenbau GmbH, Tübingen (DE)

(72) Inventors: Andreas BODMER, Meßstetten (DE); Tobias BOSCH, Hirrlingen (DE)

(21) Appl. No.: 17/432,932

(22) PCT Filed: Feb. 14, 2020
(86) PCT No.: PCT/EP2020/053952

§ 371 Date: Aug. 22, 2021

(30) Foreign Application Priority Data
Feb. 21, 2019 (DE) 10 2019 104 420.0

(51) Int. Cl. B25J 9/16; B25J 13/08; B25J 15/00; B23Q 15/12; G05B 19/4155

(52) U.S. Cl. CPC B25J 9/1687; B25J 13/084; G05B 2219/40269; B23Q 15/12; G05B 19/4155; B25J 15/0052

(57) ABSTRACT

An arrangement including a machine tool with a chuck, a measuring device, a robot arm as well as a control device. The chuck is rotatable about a chuck axis. The robot arm carries at its free end a gripping device for reception of a workpiece. The measuring device has two sensor units. The measuring device has two sensor units. By means of the control device an automatic adjustment method can be carried out. First the robot arm is controlled for gripping a workpiece and subsequently the workpiece is positioned in the range of the measurement locations of the sensor units depending on measurement signals such that the deviation in the inclination and the offset between the workpiece axis and the chuck axis is within a predefined tolerance range. This procedure is at least carried out in two different rotation positions and is iteratively repeated if necessary.

### CROSS REFERENCE TO RELATED APPLICATIONS

This application is a National Stage of PCT Application No. PCT/EP2020/053952 filed on Feb. 14, 2020, which claims priority to German Patent Application No. 10 2019 104 420.0 filed on Feb. 21, 2019, the contents each of which are incorporated herein by reference thereto.

### TECHNICAL FIELD

The invention refers to an arrangement comprising a machine tool with a chuck that is rotatable about a chuck axis, a measuring device with two sensor units, a robot arm with a gripping arrangement and a control device. The arrangement is configured to execute a method in order to adjust the robot arm with the gripping arrangement relative to a coordinate system of the machine tool. The invention also refers to a method for adjusting the robot arm with the gripping arrangement with reference to the coordinate system of the machine tool.

### BACKGROUND

Robots with a gripping arrangement for carrying out an automatic workpiece change in machine tools are known. In common robot arms their exact positioning relative to the chuck of the machine tool can be problematic in order to execute an automatic workpiece change. Depending from the configuration of the chuck and the size of the workpiece, often only a small play remains in order to carry out the collision-free insertion of the workpiece in the chuck. The position of a gripping device at the free end of a robot arm depends, for example, from the extension of the robot arm. Between individual arm sections of the robot arm connected with each other in a hinged or pivotable manner, different loads occur depending from the kink angle or extension position between two arm sections, due to elasticities and reachable positioning accuracies at the hinge connection. If the robot arm is adjusted in one position relative to the coordinate system of the machine tool, it cannot be guaranteed that the gripping device can also be positioned with sufficient accuracy by the robot arm also in other positions within the working area of the machine tool.

### BRIEF SUMMARY

Thus, it can be considered as object of the present invention to increase the accuracy of the positioning of the gripping device during insertion or removal of workpieces in the chuck of the machine tool.

Disclosed is an arrangement including a machine tool with a chuck rotatable about a chuck axis, a measuring device with two sensor units, a robot arm with a gripping device and a control device, wherein the measuring device is configured to be attached to the chuck such that the two sensor units are each assigned to different measurement locations along the chuck axis of the chuck, wherein each sensor unit of the two sensor units is configured to measure a distance of an outer surface of a workpiece from the chuck axis and to transmit a measurement signal corresponding to the distance to the control device, and wherein the control device is configured to carry out the following steps: a) control of the robot arm for gripping the workpiece, b) control of the robot arm for positioning the workpiece in a range of the different measurement locations of the sensor units adjacent to the chuck, c) control of the robot arm for positioning the workpiece based on the measurement signal such that a deviation between a workpiece axis of the workpiece and the chuck axis is within a predefined tolerance range, wherein the chuck and the measuring device attached thereon are in a first rotation position about the chuck axis, d) control of the machine tool for rotating the chuck and the measuring device arranged thereon about the chuck axis in a second rotation position different from the first rotation position, and e) checking of a position of the workpiece based on the measurement signal to determine whether the deviation between the workpiece axis and the chuck axis is within a predefined tolerance range and if not control of the robot arm for positioning the workpiece such that the deviation between the workpiece axis and the chuck axis is within the predefined tolerance range, wherein the chuck and the measuring device arranged thereon are in the second rotation position about the chuck axis.

Also disclosed is a method for adjusting a robot arm with a gripping device relative to a chuck rotatable about a chuck axis of a machine tool by using a measuring device with two sensor units including the following steps: attaching of the measuring device at the chuck such that each one of the two sensor units are assigned to different measurement locations along the chuck axis of the chuck, gripping a workpiece with the gripping device of the robot arm, moving of the robot arm such that the workpiece is positioned in a range of the different measurement locations of the two sensor units adjacent to the chuck, positioning of the workpiece by moving the gripping device based on measurement values of the two sensor units such that a deviation between the workpiece axis and the chuck axis is within a predefined tolerance range, wherein the chuck and the measuring device arranged thereon are in a first rotation position about the chuck axis, rotating the chuck and the measuring device arranged thereon about the chuck axis in a second rotation position different from the first rotation position, and checking of a position of the workpiece based on the measurement values of the two sensor units and whether the deviation between the workpiece axis and the chuck axis is within a predefined tolerance range and if not, positioning of the workpiece such that the deviation between the workpiece axis and the chuck axis is within a predefined tolerance range, wherein the chuck and the measuring device arranged thereon are in the second rotation position about the chuck axis.

The inventive arrangement comprises a machine tool with a chuck rotatable about a chuck axis, a measuring device with two sensor units, a robot arm with one or more gripping devices and a control device. The control device can be part of the control of the robot arm and/or the machine tool. The robot arm and the machine tool can be controlled via a common or via separate control devices. The sensor units of the measuring device are communicatively connected with the control device, wherein the communication connection can be wireless or wired.

The measuring device is configured to be attached at the chuck such that the measuring device with the sensor units can collectively rotate with the chuck about the chuck axis. In doing so, the chuck with the measuring device can be moved into different rotation positions about the chuck axis. In the attached condition the sensor units of the measuring device are assigned to different measurement locations along the chuck axis of the chuck. The measurement locations are arranged with distance to each other in extension direction of the chuck axis. Each sensor unit measures at the one assigned measurement location and is configured to measure a distance of a workpiece outer surface from the chuck axis at the respective measurement location and to transmit a measurement signal that describes this distance to the control device. Thus, the position of a workpiece surface radial to the chuck axis can be determined at each measurement location.

In order to adjust the gripping device relative to the chuck axis, the control device of the arrangement is configured to automatically execute the subsequently described steps, wherein manual operating actions of an operator are not necessary.

In a step a) the gripping device is controlled for gripping a workpiece. If the robot arm comprises multiple and particularly two gripping devices at its free end, a workpiece is gripped by each gripping device.

If the robot arm comprises multiple gripping devices, the gripping device is used in the subsequent steps that is provided and configured for insertion of a workpiece in the chuck. Alternatively, the subsequent steps can also be executed for all of the gripping devices.

In a step b) the gripping device is controlled in order to position the workpiece in the range of the measurement locations of the sensor units next to the chuck. In this position each sensor unit creates a measurement value or a measurement signal that indicates the distance of the workpiece outer surface located at the measurement location from the chuck axis.

In a step c) the robot arm is controlled for positioning the workpiece based on the measurement signals of the sensor units. The positioning of the workpiece is carried out such that the deviation between the workpiece axis of the workpiece and the chuck axis is within a predefined tolerance range. For example, the workpiece can be an at least in sections cylindrical workpiece, wherein the workpiece axis forms the longitudinal axis of the at least one cylindrical section. The position of the workpiece is defined by the distance of the workpiece axis from the chuck axis and the inclination of the workpiece axis relative to the chuck axis. It is the goal to position the workpiece relative to the chuck axis such that the workpiece axis corresponds with the chuck axis as far as possible, so that the workpiece axis extends along the chuck axis.

In this step c) the chuck with the measuring device is in a first rotation position about the chuck axis. The first rotation position can be adjusted either by control of the chuck or the machine tool after the arrangement of the measuring device at the chuck, or the measuring device can be attached at the chuck in the first rotation position such that a subsequent rotation of the chuck about the chuck axis can be omitted.

After having positioned the workpiece in step c) in the first rotation position, the control device controls the machine tool or the chuck in order to initiate a rotation of the chuck in a second rotation position about the chuck axis (step d)). The second rotation position deviates from the first rotation position. Preferably a rotation of the chuck about 90° is carried out between the first rotation position and the second rotation position. In an embodiment the sensor units measure in the first rotation position in a first plane that is orientated radial to the chuck axis and in the second rotation position in a second plane that is orientated radial to the chuck axis. The first plane can be a horizontal plane and the second plane can be a vertical plane or vice versa.

In the second rotation position the control device first checks the position of the workpiece based on the measurement signals to the effect whether the deviation between the workpiece axis and the chuck axis is within a predefined tolerance range and if not, the control device controls the robot arm in order to position the workpiece based on the measurement signals within the tolerance range relative to the chuck axis (step e)). The positioning in this step e) is carried out analog to the positioning in step c). Also in step e) the workpiece is positioned such that the deviation between the workpiece axis and the chuck axis is within a predefined tolerance range. The tolerance ranges can be preferably identical in step c) and in step e).

Due to the positioning of the workpiece in the two different rotation positions of the chuck or the measuring device respectively, a repeatable accuracy for positioning a workpiece by means of a gripping device adjacent to the chuck is achieved such that subsequently by a relative movement between the workpiece and the chuck along the chuck axis, a collision-free insertion of the workpiece in the chuck is possible. In doing so, preferably only the chuck is moved and the workpiece remains in its position in relation to the stationary coordinate system of the machine tool. Because the adjustment of the robot arm or the gripping device is carried out in the position in which the workpiece is inserted during operation, positioning inaccuracies of the robot arm are considered. The robot arm is adjusted directly adjacent to the chuck relative to the chuck axis with high accuracy such that a repeatable positioning accuracy of the workpiece relative to the chuck axis is achieved and collisions during insertion of a workpiece in a chuck can be avoided, even if between the workpiece and the chuck only a small play remains that is available for the insertion.

During removal of a machined workpiece from the chuck a clamping of the workpiece in the chuck can occur in case of an inaccurate positioning of the gripping device. In the clamped position the machined workpiece is exactly aligned along the chuck axis and the robot arm can grip the machined workpiece with the gripping device. Subsequently the machined workpiece can be removed from the chuck by a relative movement along the chuck axis between the gripping device and the chuck, preferably only by a movement of the chuck.

It is advantageous, if the control device is configured to execute the following steps subsequent to step e): Step f): Control of the machine tool or the chuck in order to rotate the chuck and the measuring device arranged thereon out of the second rotation position in the first rotation position and step g): Checking the position of the workpiece based on the measurement signals whether the deviation between the workpiece axis and the chuck axis is within the predefined tolerance range and if not, control of the robot arm for positioning the workpiece such that the deviation between the workpiece axis and the chuck axis is within a predefined tolerance range, wherein the chuck and the measuring device arranged thereon are in the first rotation position about the chuck axis.

Subsequently one or more of the steps d) to g) can be repeated. The repeating of one or more of the steps d) to g) is executed as often until it is complied with the predefined tolerance range in both rotation positions. This repeating can be necessary, because due to the positioning of the workpiece in one rotation position, in turn also the position of the workpiece in the respective other rotation position is influenced. It is, therefore, advantageous to again adjust the first rotation position after step e) and to continue the method at least as long as after the rotation of the chuck in the first rotation position or the second rotation position a change of the position of the workpiece is not necessary anymore.

It is in addition advantageous, if the control device is configured to control the robot arm during positioning of the workpiece in steps c), e) and g) such that first the workpiece axis is orientated parallel to the chuck axis within the predefined tolerance range and subsequently a movement of the workpiece orthogonal to the workpiece axis is carried out until the distance between the workpiece axis and the chuck axis is within the tolerance range at both measurement locations. This distance is characterized by the respective measurement signals at the measurement locations. In other words the workpiece is first aligned in its inclination relative to the chuck axis in steps c), e) and g) and subsequently moved parallel to the chuck axis and centered. The positioning of the workpiece in steps c), e) and g) is thus preferably double stage.

It is preferred, if the control device is configured to control the robot arm for positioning of the workpiece dependent on a workpiece diameter and/or the gripping position of the gripping device at the workpiece. The workpiece diameter and/or the gripping position can be predefined to the control device directly, e.g. via a user interface of the machine tool, or indirectly by one or more other parameters. The at least one parameter can be manually input or can be automatically detected. The gripping position describes particularly the distance between the location at which the gripping device engages the workpiece and one or both free ends of the workpiece.

The sensor units can be configured as tactile operating sensor units and, for example, formed by a respective dial gauge. Alternatively, also contactless operating sensor units, e.g. optical and/or electromagnetic distance sensors can be used.

The inventive method can be carried out under use of one of the embodiments of the arrangement described previously. Alternatively or additionally, one or more steps can also be carried out by alternative means or devices. The inventive method comprises the following steps:

First, the measuring device is attached to the chuck such that the sensor units can measure at the different measurement locations along the chuck axis. The measuring device is attached at the chuck such that the measuring device can commonly rotate with the chuck about the chuck axis. The attachment of the measuring device can be carried out in the first rotation position of the chuck or the chuck can be rotated in the first rotation position about the chuck axis after attaching of the measuring device.

By means of the robot arm or its gripping device a workpiece is gripped. The robot arm is moved such that the gripping device positions the workpiece in the range of the measurement locations of the sensor unit adjacent to the chuck such that each sensor unit can detect a measurement value at the respective measurement location. Then the workpiece is positioned by moving the gripping device or the robot arm depending on the measurement signals of the sensor unit. During positioning the inclination of the workpiece axis relative to the chuck axis and the distance of the workpiece axis from the chuck axis are adjusted such that it is complied with a predefined tolerance range.

Subsequently the chuck is moved out of the first rotation position in the second rotation position, preferably about approximately 90°. In the second rotation position the position of the workpiece is checked whether the deviation between the workpiece axis and the chuck axis is within a predefined tolerance range and if not, analog to the process in the first rotation position, the workpiece is positioned such that the workpiece axis is positioned relative to the chuck axis within a predefined tolerance range (inclination and distance).

The checking and as necessary positioning of the workpiece in the first rotation position at the second rotation position can be repeatedly carried out until it is determined subsequent to the rotation of the chuck from the first rotation position in the second rotation position or from the second rotation position in the first rotation position that no change in the position of the workpiece is necessary anymore in order to comply with the tolerance range.

Advantageous embodiments of the invention are derived from the dependent claims, the specification and the drawings.

### BRIEF DESCRIPTION OF THE DRAWINGS

In the following preferred embodiments of the invention are explained in detail based on the attached drawings. The drawings show:

FIG. 1 a block diagram of an embodiment of an arrangement comprising a machine tool, a measuring device, a robot arm and a control device,

FIG. 2 the illustration of the chuck of the machine tool of FIG. 1 with a measuring device arranged thereon,

FIG. 3 the adjustment of the sensor units of the measuring device of FIG. 2 by means of a workpiece clamped in the chuck,

FIGS. 4 and 5 the chuck with the measuring device arranged thereon in a first rotation position,

FIGS. 6 to 8 the positioning of a workpiece held by a gripping device of the robot arm of FIG. 1 adjacent to the chuck relative to a chuck axis of the chuck and

FIGS. 9 and 10 the chuck with the arranged measuring device in a second rotation position about the chuck axis.

### DETAILED DESCRIPTION

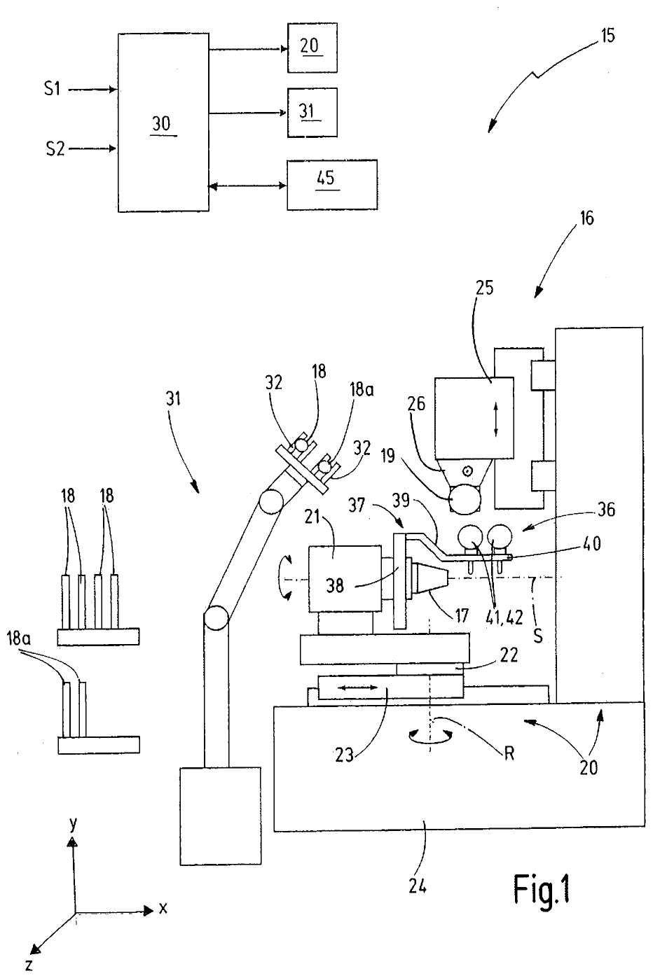

In FIG. 1 a block diagram of an embodiment of an arrangement 15 is highly schematically illustrated. A machine tool 16 with a chuck 17 rotatable about a chuck axis S is part of the arrangement 15. The chuck axis S is orientated horizontally according to the example, but could also have a vertical or another arbitrary orientation. The chuck 17 is configured for clamping a workpiece 18 to be machined. The workpiece 18 is particularly a rod-like workpiece that can be at least in sections cylindrically. For the subsequently described method a circular cylindrical workpiece with constant diameter is used as a workpiece 18.

The machine tool 16 has a tool 19 for machining the workpiece 18. According to the example, the machine tool 16 is a grinding machine, an eroding machine or a combined grinding and eroding machine. The tool 19 is thus a grinding tool and/or an eroding tool.

By means of a machine axis 20 of the machine tool, the tool 19 and the chuck 17 can be moved and positioned relative to each other. The number of linear axes and/or rotation axes of the machine axis arrangement 20 can vary. A first rotation axis 21 serves for rotationally driving the chuck 17 about the chuck axis S. A second rotation axis 22 serves for pivoting or rotating of the chuck 17 about a rotation axis R that is orientated orthogonal to the chuck axis S according to the example. In addition, in the exemplary machine tool 16 a first linear axis 23 for moving the chuck 17 in an x-direction relative to a machine base 24 or a machine frame, a second linear axis 25 for moving the tool 19 in a y-direction relative to the machine base 24 or the machine frame, as well as a third linear axis 26 for moving tool 19 in a z-direction relative to the machine base 24 of a machine frame are present. The number and stacking of the machine axis of the machine axis arrangement 20 can vary and can be selected depending on the machine tool.

The machine axis arrangement 20 is controlled by means of a control device 30.

A robot arm 31 is part of the arrangement 15 at the free end of which at least one gripping device 32 is provided. In the embodiment illustrated in FIG. 1 the robot arm 31 has two gripping devices 32 such that a workpiece 18 to be machined, as well as a completely machined workpiece 18a can be gripped concurrently. For example the robot arm 31 is configured to take a workpiece 18 that still is to be machined from a pallet, to transport it to the chuck 17, to first remove the previously machined workpiece 18a there and to insert the subsequent workpiece 18 to be machined. Then the removed completely machined workpiece 18a can be stored in a further pallet. In doing so, the robot arm 31 can execute an automatic workpiece exchange. During the automatic workpiece exchange the workpiece 18 to be inserted is positioned along the chuck axis or the clamped machined workpiece 18a is gripped. The relative movement between chuck 17 and the workpiece 18, 18a during insertion or removal is executed only by chuck 17 according to the example, whereas the gripping device 32 of the robot arm 31 retains the workpiece 18, 18a without an active own movement. The robot arm 31 is controlled by the control device 30 according to the example. Thus, the control device 30 can be a superordinate control for the machine tool 16 and the robot arm 31. The control device 30 can be integrated as hardware and/or software in the control of robot arm 31 and/or the machine tool 16.

The arrangement 15 further comprises a measuring device 36. The measuring device 36 has a holding device 37 by means of which the measuring device 36 can be attached to the chuck 17. In the attached condition of the holding device 37 at the chuck 17, the measuring device 36 rotates commonly with chuck 17 about the chuck axis as if the first rotation axis 21 is driven. According to the example, the holding device 37 has a ring 38 that surrounds a section of the chuck 27 and can be fixed at the chuck by a releasable connection, particularly a screw connection. A cantilever 39 of the holding device 37 extends from the ring 38 that comprises a section 40 extending substantially parallel to the chuck axis S, if the holding device 37 is attached at the chuck 17.

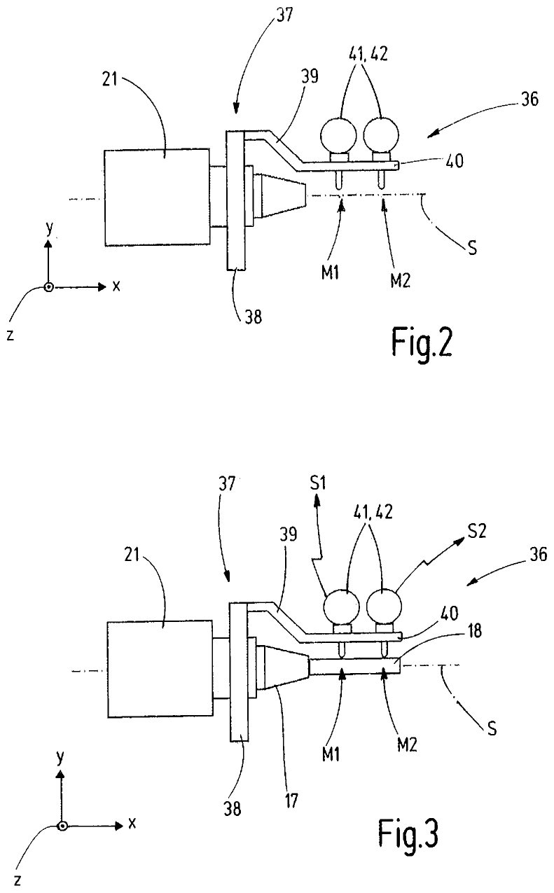

At the cantilever 39, and according to the example at section 40 of the holding device 37, two sensor units 41 are arranged. Each sensor unit 41 is configured to detect a measurement signal at an assigned measurement location M1, M2 (FIG. 2) respectively that characterizes a distance of a workpiece surface facing the sensor unit 41 from the chuck axis S. In the embodiment the sensor units 41 are configured as tactile sensing sensor units and are formed according to the example by a dial gauge 42 respectively. The stylus or tactile body of each dial gauge 42 abuts during measurement of a workpiece 18 at its workpiece outer surface and provides a respective measurement value. Each sensor unit 41 is communicatively connected with the control device 30. Depending on the measurement value detected at the assigned measurement locations M1, M2, each sensor unit 41 creates a measurement signal S1 or S2 respectively that is transmitted to the control device 30 (FIG. 1). In the embodiment the sensor units 41 are wirelessly communicatively coupled with the control device 30. The communication connection can be alternatively in sections or completely wired.

As it is further schematically illustrated in FIG. 1, arrangement 15 and preferably machine tool 16 comprise a user interface 45. Via the user interface 45 a user can input information or the control device 30 can output information for the user. The user interface 45 can comprise commonly known means, like e.g. a monitor, a keyboard, a touch-sensitive screen, a touch-sensitive area, a computer mouse, etc.

By means of the measuring device 36, the robot arm 31 is adjusted relative to the chuck 17, if the chuck 17 is in a workpiece exchange position. In this workpiece exchange position the gripping device 32 that is configured or used for the insertion of a new workpiece 18 to be machined is positioned or adjusted relative to the chuck axis S such that the workpiece 18 to be machined can be inserted in the chuck 17 without collision. The adjustment of the robot arm 31 is carried out with the method described subsequently that can be substantially automatically executed by the control device 30.

As it is illustrated in FIG. 2, first the measuring device 36 is attached at the chuck 17. The first measurement location M1 and the second measurement location M2 of the two sensor units 41 are arranged with distance to each other along the chuck axis S. The two sensor units 41 or dial gauges 42 measure orthogonal or radial to the chuck axis S. For preparing the adjustment method of the robot arm 31, the sensor units 41 are adjusted or calibrated in that a workpiece 18 is clamped in the chuck 17 that thus has an ideal orientation relative to the chuck axis S. The sensor units 41 or dial gauges 42 are adjusted to a reference value, e.g. zero, respectively. The measurement value at the first measurement location M1 is characterized by the first measurement signal S1 and the measurement value at the second measurement location M2 is characterized by the second measurement signal S2, wherein the measurement signals S1, S2 are transmitted to the control device 30 that can output the measurement values via the user interface 45. This calibration or initialization of the measuring device 36 is illustrated in FIG. 3. As an option chuck 17 can be arranged together with the measuring device 36 in one or more rotation positions about the chuck axis S in order to check whether the calibrated reference value of the sensor units 41 can also be maintained in different rotation positions—at least up to an allowable deviation.

After calibration of the measuring device 36 the workpiece 18 is removed from the chuck 17 and the subsequent method can be carried out manually or automatically by the control device 30.

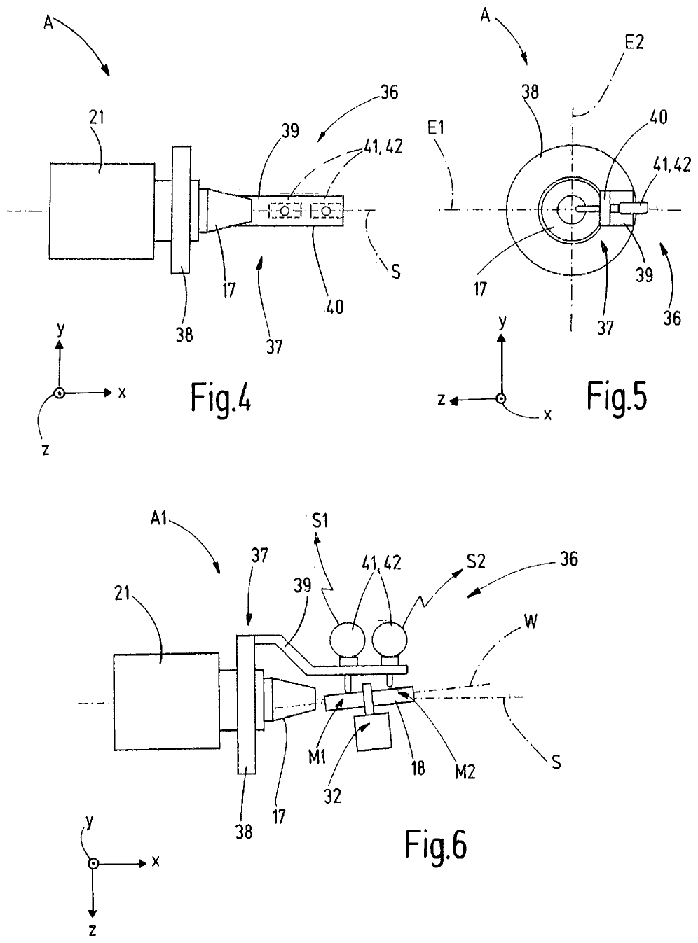

First, the chuck 17 is moved commonly with the measuring device 36 in a first rotation position A that is illustrated in FIGS. 4-8. In the first rotation position A the sensor units 41 measure in a first plane E1 radially to the chuck axis S that is orientated substantially horizontally according to the example.

In this first rotation position A of the chuck 17 and the measuring device 36 about the chuck axis S, then by means of a robot arm 31 a workpiece 18 held by the gripping device 32 is positioned in the area of the measurement locations M1, M2 and is, according to the example, brought into contact with the tactile bodies or stylus of the dial gauges 42. It is the goal of the positioning of the workpiece 18 to arrange a workpiece axis W that corresponds to the longitudinal axis in the case of a circular cylindrical workpiece as far as possible exactly along the chuck axis S such that a predefined tolerance range is complied with.

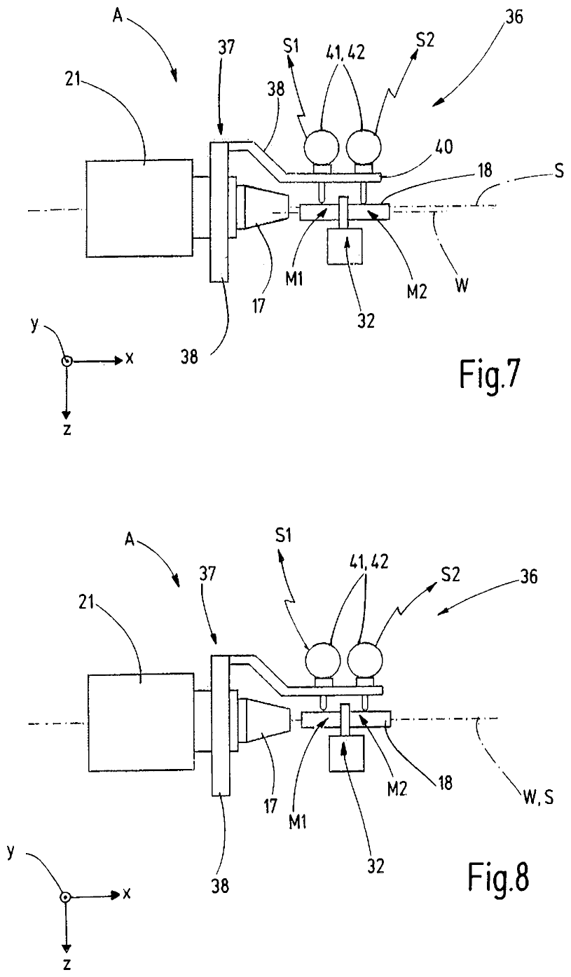

As illustrated in FIG. 6, the two sensor units 41 transmit their respective measurement signals S1, S2 to the control device 30. The control device 30 evaluates the measurement signals S1, S2 and controls the robot arm 31 with the gripping device 32 in order to reach the desired positioning of workpiece 18. First, the gripping device 32 and thus the workpiece 18 and the workpiece axis W are orientated such that the workpiece axis W is orientated within the allowable tolerance range parallel with the chuck axis S (FIG. 7). A sufficient parallelism between the workpiece axis W and the chuck axis S is achieved, if both sensor units 41 detect substantially the same measurement value, because the workpiece 18 is circular cylindrical according to the example. The measurement values between the two sensor units 41 must only deviate from each other in the allowed tolerance range.

Following the parallel alignment of the workpiece axis W to the chuck axis S the workpiece 18 is moved orthogonal to the chuck axis S until the workpiece axis W coincides as far as possible with the chuck axis S, wherein it is also sufficient here, if an allowable tolerance range is complied with. If the workpiece 18 held by the gripping device 32 comprises the same dimensions and particularly the same diameter as the workpiece 18 that was used for calibrating of the measuring device 36 (FIG. 3), then the respective measurement values at the two measurement locations M1, M2 correspond in the ideal case to the calibrated reference values. If the workpiece diameter of the workpiece 18 held by the gripping device 32 deviates from the diameter of the workpiece 18, the diameter of the currently used workpiece 18 can be predefined for the control device 30 such that the measurement value that the sensor units 41 have to detect can be calculated, if the workpiece axis W is positioned along the chuck axis S (FIG. 8).

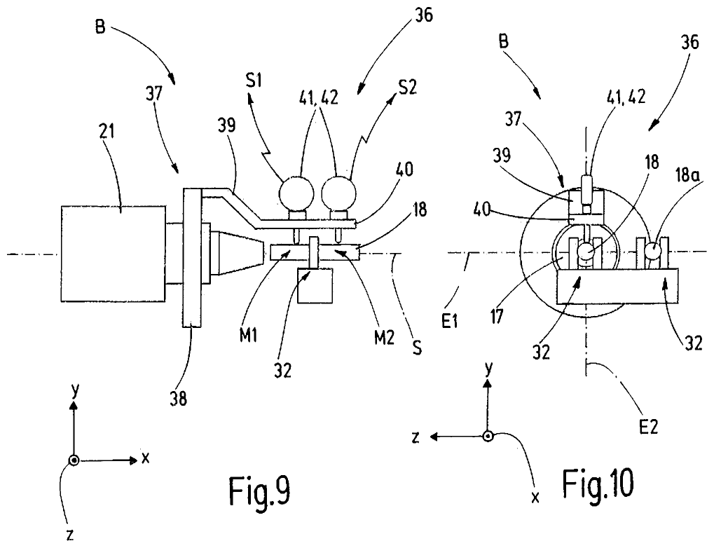

After positioning of the workpiece 18 in the first rotation position A with sufficient accuracy has been achieved, the control device 30 initiates the rotation of chuck 17 with the measuring device 36 about the chuck axis S in the second rotation position B that is illustrated in FIGS. 9 and 10. The workpiece 18 that is held by the gripping device 32 of the robot arm 31 remains unchanged in the position that was previously reached in the first rotation position A.

As it is apparent from FIGS. 9 and 10, the first rotation position A and the second rotation position B are offset relative to each other approximately about 90°. In the second rotation position B the sensor units 41 measure in a second plane E2 that is orientated radial to the chuck axis S and is orientated substantially orthogonal to the first plane E1. The second plane E2 can be, e.g. a vertical plane.

In the second rotation position B the measurement values of the sensor units 41 at the first measurement location M1 and the second measurement location M2 characterized by the sensor signals S1, S2 are evaluated by the control device 30. If the workpiece 18 is not positioned within the predefined tolerance range with reference to the chuck axis S and for example has an offset that is too large or an inclination that is too large, the movements of the gripping device 32 are carried out that are shown in FIGS. 6-8 and were explained with reference to the first rotation position A until the measurement values in the second rotation position B are within the predefined tolerance range.

If the position of the workpiece 18 in the second rotation position B has been changed again, the control device 30 initiates the movement of the measuring device 36 back in the first rotation position A and the measurement values are again evaluated in the first rotation position A. If necessary, also here workpiece 18 is moved and positioned again, if this is necessary in order to comply with the predefined tolerance range.

The positioning of the workpiece 18, if the measuring device 36 is in the first rotation position A or the second rotation position B, is continued as long as after the movement of the measuring device 36 in a respective rotation position A or B, it is determined that no movement of the workpiece 18 by means of the robot arm 31 is necessary anymore in order to comply with the predefined tolerance range. Then the workpiece 18 is sufficiently exactly positioned in both rotation positions A, B of the measuring device 36 such that the workpiece axis W is arranged with sufficient accuracy along the chuck axis S. The adjustment method of the robot arm 31 is then completed.

If the robot arm 31 comprises two gripping devices 32 at its free end, according to the example in both gripping devices 32 one workpiece 18 is gripped respectively, if the gripping device 32 used for insertion of the workpiece 18 to be machined is adjusted along the chuck axis S as described above, if the chuck 17 is in the workpiece exchange position. In doing so, it is avoided that deviations due to different loads or weight forces occur. Because first a completely machined workpiece 18a is removed by the second gripping device and only subsequently the workpiece 18 to be machined is inserted into chuck 17 such that during the insertion a respective higher load or weight force acts on the free end of the robot arm 31 that is thus automatically considered during the adjustment.

If the weights of the workpieces deviate from each other, the adjustment method must be carried out again for another type of workpiece with higher or lower weight or the control device 30 calculates, depending on the weight difference of the workpieces, correction values such that the position for the insertion of the workpiece in the chuck 17 can be maintained with sufficient accuracy also for different types of workpieces with different weights.

Because the sensor units 41 are communicatively coupled with the control device 30 and transmit respective measurement signals S1, S2, the adjustment method can be carried out automatically. It is also possible to manually execute the method steps by a user in that it is indicated via the user interface 45 or directly via the sensor units 41, if the positioning of the workpiece 18 and the first rotation position A or the second rotation position B of the measuring device 36 has reached a sufficient accuracy. The positioning of workpiece 18 by means of the robot arm 31 can be corrected by respective user inputs.

The invention refers to an arrangement 15 comprising a machine tool 16 with a chuck 17, a measuring device 36, a robot arm 31 as well as a control device 30. The chuck 17 is rotatable about a chuck axis S. The robot arm 31 carries at its free end a gripping device 32 for reception of a workpiece 18. The measuring device 36 has two sensor units 41. The measuring device 36 is configured to be attached at the chuck 17 such that it can commonly rotate with chuck 17 about the chuck axis S. The sensor units 41 are assigned to different measurement locations M1, M2 along the chuck axis S and can measure a distance of a workpiece outer surface at the measurement locations M1 or M2 of the workpiece 18 from the chuck axis S and create measurement signals S1 or S2 respectively describing this distance and can transmit the measurement signals S1, S2 to the control device 30. By means of the control device 30 an automatic adjustment method can be carried out. First the robot arm 31 is controlled for gripping a workpiece 18 and subsequently the workpiece 18 is positioned in the area of the measurement locations M1, M2. The positioning is carried out by controlling the robot arm 31 based on the measurement signals S1, S2 until the deviation of the inclination and the offset between the workpiece axis W and the chuck axis S is within a predefined tolerance range. This procedure is at least carried out in two different rotation positions A, B and if necessary, repeated iteratively.

### LIST OF REFERENCE SIGNS

15 arrangement
16 machine tool
17 chuck
18 workpiece
18a completely machined workpiece
19 tool
20 machine axis arrangement
21 first rotation axis
22 second rotation axis
23 first linear axis
24 machine base
25 second linear axis
26 third linear axis
30 control device
31 robot arm
32 gripping arrangement
36 measuring device
37 holding device
38 ring
39 cantilever
40 section of the cantilever
41 sensor unit
42 dial gauge
45 user interface
A first rotation position
B second rotation position
E1 first plane
E2 second plane
M1 first measurement location
M2 second measurement location
S chuck axis
S1 measurement signal
S2 measurement signal
W workpiece axis

1. An arrangement comprising a machine tool with a chuck rotatable about a chuck axis, a measuring device with two sensor units, a robot arm with a gripping device and a control device,
wherein the measuring device is configured to be attached to the chuck such that both the two sensor units are each assigned to different measurement locations along the chuck axis of the chuck, wherein each sensor unit of the two sensor units is configured to measure a distance of an outer surface of a workpiece from the chuck axis and to transmit a measurement signal corresponding to the distance to the control device,
and wherein the control device is configured to carry out the following steps:
a) control of the robot arm for gripping the workpiece,
b) control of the robot arm for positioning the workpiece in a range of the different measurement locations of the sensor units adjacent to the chuck,
c) control of the robot arm for positioning the workpiece based on the measurement signal such that a deviation between a workpiece axis of the workpiece and the chuck axis is within a predefined tolerance range, wherein the chuck and the measuring device attached thereon are in a first rotation position about the chuck axis,
d) control of the machine tool for rotating the chuck and the measuring device arranged thereon about the chuck axis in a second rotation position different from the first rotation position, and
e) checking of a position of the workpiece based on the measurement signal to determine whether the deviation between the workpiece axis and the chuck axis is within a predefined tolerance range and if not control of the robot arm for positioning the workpiece such that the deviation between the workpiece axis and the chuck axis is within the predefined tolerance range, wherein the chuck and the measuring device arranged thereon are in the second rotation position about the chuck axis.

2. The arrangement according to claim 1, wherein the control device is configured to carry out the following steps after the step e):
control of the machine tool for rotating of chuck and the measuring device arranged thereon about the chuck axis in the first rotation position and
g) checking of the position of the workpiece based on the measurement signal to determine whether the deviation between the workpiece axis and the chuck axis is within the predefined tolerance range and if not, control of the robot arm for positioning the workpiece such that the deviation between the workpiece axis and the chuck axis is within the predefined tolerance range, wherein the chuck and the measuring device arranged thereon are in the first rotation position about the chuck axis.

3. The arrangement according to claim 2, wherein the control device is configured to repeat at least the steps d) through g) until a position of the workpiece relative to the chuck axis is sufficiently accurate such that the deviation between the workpiece axis and the chuck axis is within the predefined tolerance range in the first rotation position as well as in the second rotation position.

4. The arrangement according to claim 2, wherein the control device is configured to control the robot arm during positioning of the workpiece in the steps c), e) and g) such that first the workpiece axis is orientated parallel to the chuck axis within the predefined tolerance range and subsequently to move the workpiece orthogonal to the chuck axis until the distance between the workpiece axis and the chuck axis is within the tolerance range at the different measurement locations.

5. The arrangement according to claim 1, wherein the control device is configured to control the robot arm for positioning the workpiece depending on a workpiece diameter and/or a gripping position of the gripping device at the workpiece.

6. The arrangement according to claim 1, wherein the two sensor units are configured as tactile operating sensor units.

7. The arrangement according to claim 6, wherein the two sensor units are each formed by a dial gauge.

8. The arrangement according to claim 1, wherein the two sensor units are wirelessly communicatively coupled with the control device.

9. The arrangement according to claim 1, wherein the robot arm comprises two gripping devices.

10. The arrangement according to claim 9, wherein one of the two gripping devices of the robot arm grips the workpiece and the other one of the two gripping devices grips another workpiece in step a).

11. A method for adjusting a robot arm with a gripping device relative to a chuck rotatable about a chuck axis of a machine tool by using a measuring device with two sensor units comprising the following steps:
attaching of the measuring device at the chuck such that each one of the two sensor units are assigned to different measurement locations along the chuck axis of the chuck,
gripping a workpiece with the gripping device of the robot arm,
moving of the robot arm such that the workpiece is positioned in a range of the different measurement locations of the two sensor units adjacent to the chuck,
positioning of the workpiece by moving the gripping device based on the measurement values of the two sensor units such that a deviation between the workpiece axis and the chuck axis is within a predefined tolerance range, wherein the chuck and the measuring device arranged thereon are in a first rotation position about the chuck axis,
rotating the chuck and the measuring device arranged thereon about the chuck axis in a second rotation position different from the first rotation position, and
checking of a position of the workpiece based on the measurement values of the two sensor units and whether the deviation of between the workpiece axis and the chuck axis is within a predefined tolerance range and if not, positioning of the workpiece such that the deviation between the workpiece axis and the chuck axis is within a predefined tolerance range, wherein the chuck and the measuring device arranged thereon are in the second rotation position about the chuck axis.

12. The arrangement according to claim 3, wherein the control device is configured to control the robot arm during positioning of the workpiece in the steps c), e) and g) such that first the workpiece axis is orientated parallel to the chuck axis within the predefined tolerance range and subsequently to move the workpiece orthogonal to the chuck axis until the distance between the workpiece axis and the chuck axis is within the tolerance range at the different measurement locations.

13. The arrangement according to claim 2, wherein the control device is configured to control the robot arm for positioning the workpiece depending on a workpiece diameter and/or a gripping position of the gripping device at the workpiece.

14. The arrangement according to claim 3, wherein the control device is configured to control the robot arm for positioning the workpiece depending on a workpiece diameter and/or a gripping position of the gripping device at the workpiece.

15. The arrangement according to claim 12, wherein the control device is configured to control the robot arm for positioning the workpiece depending on a workpiece diameter and/or a gripping position of the gripping device at the workpiece.

16. The arrangement according to claim 15, wherein the two sensor units are configured as tactile operating sensor units.

17. The arrangement according to claim 16, wherein the two sensor units are each formed by a dial gauge.

18. The arrangement according to claim 17, wherein the two sensor units are wirelessly communicatively coupled with the control device.

19. The arrangement according to claim 18, wherein the robot arm comprises two gripping devices.

20. The arrangement according to claim 19, wherein one of the two gripping devices of the robot arm grips the workpiece and the other one of the two gripping devices grips another workpiece in step a).
